(19) United States
(12) Patent Application Publication
(10) Pub. No.: US 2012/0248058 A1
(43) Pub. Date: Oct. 4, 2012

(54) CARTRIDGE HAVING A PLUG

(75) Inventor: Sasan Habibi-Naini, Rikon (CH)

(73) Assignee: Sulzer Mixpac AG, Haag (CH)

(21) Appl. No.: 13/515,612

(22) PCT Filed: Dec. 15, 2010
(86) PCT No.: PCT/EP10/69745

§ 371 Date: Jun. 13, 2012

(30) Foreign Application Priority Data
Dec. 16, 2009 (EP) 09179483.4

(51) Int. Cl. B29C 69/00; B65D 1/02; B65D 25/28; B65D 39/00; B65D 25/02

(52) U.S. Cl. 215/45; 215/355; 29/414; 215/40

(57) ABSTRACT

In a method for the manufacture of a cartridge, in a first step, a storage chamber for the reception of a filler material, a neck which contains an outlet passage for the filler material, and a closure stopper are manufactured in a single workstep in an injection molding process. The outlet passage has an end, wherein an outlet opening is arranged at the end of the outlet passage. The closure stopper has an arm, wherein the outlet opening is held at least partly closed by the arm of the closure stopper. The arm has a first end, wherein the first end of the arm is connected to the neck by a bridge element. A desired break point is formed by the bridge element and the closure stopper is connected to the cartridge in one piece via the bridge element. The closure stopper has a second end, wherein, in a second subsequent step, the bridge element is cut by manipulation of the second end before the filling of the cartridge with the filler material and subsequently the arm is introduced into the outlet opening to close the outlet opening. A cartridge is furthermore shown which is manufactured in accordance with this method.

The invention relates to a cartridge which is in particular used for the processing of a plurality of components as well as to a method for the manufacture of such a cartridge. Such cartridges contain a filler material which is dispensed for a specific application. The cartridge is in particular suitable for the simultaneous dispensing of a filler material. The filler material can be made up of at least two components which can be mixed prior to the use.

Conventional cartridges are used for the metering of usually very small quantities of a filler material. A cartridge is a tube with a neck in its simplest embodiment. The tube serves as a storage chamber for the filler material. The tube opens into the neck at the dispensing end. A piston, which is movable to and fro within the tube, is located at the oppositely disposed end which should be called the conveying end. The neck contains an outlet passage which opens into an outlet opening through which the filler material can be discharged continuously as a jet or discontinuously in drop form. To dispense the filler material, the user pushes the piston in the direction of the neck. The filler material exits the cartridge through the outlet passage of the neck and is applied to the desired location by the user. A plurality of alternatives are available for the filling of the cartridge with filler material.

If impacts occur during transport, the cartridge, in particular the cartridge neck, can be damaged. A closure stopper such as is shown in U.S. Pat. No. 6,484,904 would introduce impact forces directly into the cartridge neck on an impact so that it is not ensured that the cartridge neck remains intact. The closure stopper in accordance with U.S. Pat. No. 6,484,904 can furthermore only be opened by a tool. The user can furthermore check whether the cartridge is intact by the closure stopper in accordance with U.S. Pat. No. 6,484,904 connected via a desired break point to the outlet of the cartridge. As long as the desired break point has not been cut, the user knows that the cartridge has never been used. However, this advantage has the effect that certain restrictions have to be accepted in the filling of the cartridge. The cartridge can only be filled via the storage chambers. It can occur during the filling that air is enclosed in the filler material, in particular with viscous materials.

The air enclosed in the filler material is, however, disadvantageous because it can influence the mixing ratio of the components during the dispensing of the filler material. Discontinuities in the dispensing of the filler material can thus occur; for example, to tear off the strand being discharged from the static mixer if an air bubble enters into the static mixer. Air can furthermore collect between the filler material and the piston so that a precise guidance of the piston is no longer possible. The piston can tilt and lose the contact to the inner wall of the storage chamber so that the seal of the piston at the inner wall is lost. Filler material can hereby be discharged from the cartridge past the sealing lip.

A possible remedy for this problem is the use of venting elements which are attached either to the inner wall of the cartridge and/or to the piston. The provision of such venting elements is therefore associated with an increased construction effort and thus with additional costs.

It is therefore an object of the invention to enable a filling of the cartridge in which air enclosed by the filler material can already be removed at the time of filling.

It is a further object of the invention to provide a closure stopper which can be opened without a tool. The neck should furthermore be secured against transport damage so that it remains intact on an impact at any angle. It is furthermore an object of the invention reliably to prevent a discharge of filler material as a consequence of an impact of the cartridge on an obstacle.

The object of the invention is satisfied by a method for the manufacture of a cartridge wherein, in a first step, a storage chamber for the reception of a filler material, a neck which contains an outlet passage for the filler material, and a closure stopper are manufactured in a single workstep in an injection molding process; wherein the outlet passage has an end; wherein an outlet opening is arranged at the end of the outlet passage; wherein the closure stopper has an arm; wherein the outlet opening is held at least partly closed by the arm of the closure stopper; wherein the arm has an end; wherein the end of the arm is connected to the neck by a bridge element; wherein a desired break point is formed by the bridge element and the closure stopper is connected to the cartridge in one piece via the bridge element; wherein the closure stopper has a second end; wherein, in a second subsequent step, the bridge element is cut by manipulation of the second end before the filling of the cartridge with the filler material and subsequently the arm is introduced into the outlet opening to close the outlet opening.

The arm can thus be removed so far from the outlet opening during the filling of the cartridge that air enclosed between the filler material and the outlet opening can be discharged.

After the filling, the arm can be introduced in the outlet passage up to an abutment so that an engagement length is formed between the abutment and the end of the arm so that the arm is introduced into the outlet passage along the engagement length so that the filler material is enclosed in the cartridge.

The cartridge includes a storage chamber for the reception of a filler material, a neck which contains an outlet passage for the filler material, and a closure stopper. The outlet passage has an end, with an outlet opening being arranged at the end of the outlet passage.

The storage chamber, the neck and the closure stopper can be manufactured in a single workstep by an injection molding process. The closure stopper has an arm, with the outlet opening being held closed at least partly by the arm of the closure stop. The arm has an end, with the end of the arm being connected to the neck by a bridge element. A desired break point is formed by the bridge element and the closure stopper is connected to the cartridge in one piece via the bridge element. The closure stop has a second end, which is arranged oppositely to the first end, with the bridge element being able to be cut by manipulation of the second end before the filling of the cartridge with the filler material and with the arm subsequently after cutting of the bridge element being able to be introduced into the outlet opening to close the outlet opening.

The bridge element has at least one opening. The bridge element can in particular be made as a web.

The arm of the closure stopper includes an end and has an abutment so that an engagement length can be formed between the abutment and the end of the arm so that the arm is introduced into the outlet passage along the engagement length when the closure stopper is closed.

By means of the second end of the closure stopper, which can in particular be formed as a handle, the position of the arm in the outlet passage can be changed.

In the closed state, the outlet opening is held closed by the arm; in the opened state, the arm is removed from the associated outlet opening so that the filler material can be dispensed through the outlet passage and through the outlet opening. The arm has an end, with the end of the arm being connected to the neck by a bridge element during the manufacture.

This bridge element has the function of a connection passage during the injection molding process to supply the required mold material to the tool serving for the manufacture of the closure stopper. This bridge element is formed as a desired break point which is cut after the manufacture of the cartridge so that the closure stopper is no longer connected to the neck in one piece. The second end of the closure stopper is in particular formed as a handle, with the arm being able to be introduced into the outlet opening by manipulation of the second end.

A sealing element is advantageously provided to close the outlet opening in a fluid tight manner after cutting the bridge element. The sealing element is, for example, a bead arranged at the outer side of the arm; a plurality of beads can also be arranged after one another. Alternatively or in addition hereto, corresponding beads can be arranged on the inner side of the outlet passage. These beads can in particular be made as ribs. The outer side of the arm can be conical at least regionally. The diameter of the cone advantageously increases as the engagement length increases so that the arm is connected to the outlet passage in a fluid-tight manner by a compression force.

The arm advantageously has a cut-out. The arm is elastic in the region of the engagement length due to this cut-out so that the arm can deform elastically. The arm can hereby be introduced more easily into the corresponding outlet passage. If the arm has a slight excess dimension with respect to the outlet passage, an additional clamping connection can be provided on the reclosing of the outlet passage. The cut-out is advantageously made as a bore which extends into the arm at least over the engagement length.

The second end of the closure stopper can be made as an impact absorption element so that the second end absorbs the impact energy on an impact and a deformation of the second end takes place, but the neck of the cartridge remains intact.

The closure stopper advantageously contains a coding element. This coding element prevents the closure stopper from accidentally being placed on incorrectly, that is prevents the arms from engaging into the wrong outlet openings. Residues of the respective component can still adhere to the ends of the arms so that a contamination of the components still located in the part chambers can occur on an incorrect placing on.

The closure stopper is in particular made such that the neck remains intact on an impact since the impact forces can be reduced by the deformation of the closure stopper.

A housing element can be received on the neck. A mixer is or can be connected to the neck, in particular when the container is made as a multicomponent cartridge. The or each of the outlet passages open into the mixer. The mixer is accommodated in an associated housing element which is pushed over the neck or is inserted into the neck. This housing element should be called a mixer housing. The mixer housing can be connected to the neck via a thread. The outlet passage is provided with an external thread onto which the housing element can be screwed

The connection can, however, also take place via a bayonet connection, via a latch connection or via a snap-in connection, which is not shown in the drawing. The mixer can in particular be made as a static mixer. A static mixer includes a plurality of flow-deflecting installations which are arranged in the mixer housing. The use of a mixer is in particular advantageous when the cartridge is used for a filler material which is made up of a plurality of flowable components.

The neck is usually made as a rotationally symmetrical component; however, it is also possible that the neck has an engagement element which is connectable to a coupling element. Alternatively to this, the mixer housing can enter into a plug-in connection, a latch connection, a snap-in connection or a bayonet connection with the neck, for example. Coding means can in particular be provided such as are shown in EP 7 390 913 to place on the mixer housing in a precisely defined position relative to the cartridge.

The closure stopper is made in one piece with the neck, that is the closure stopper is manufactured together with the neck and with the entire cartridge as a single component.

The storage chamber can have a volume which can be changed. When the filler material is dispensed, the volume of the storage chamber is reduced by a compression force applied to the wall of the storage chamber since the wall is made of a yielding material. The storage chamber can be made as a tube or as a tubular bag, for example.

Alternatively to this, the volume of the storage chamber can be changed in that a piston is moved to and fro along the inner wall of the storage chamber. The shape of the storage chamber and thus the volume enclosed by the storage chamber are thus unchangeable.

In accordance with an advantageous embodiment, the cartridge in accordance with one of the preceding embodiments contains at least one first part chamber and one second part chamber. The first part chamber can receive a first component and the second part chamber a second component. The first part chamber opens into a first outlet passage and the second part chamber opens into a second outlet passage, with the first outlet passage having a first outlet opening and the second outlet passage having a second outlet opening. In the following such containers should also be called multicomponent cartridges. It results as an additional advantage for a multicomponent cartridge that each of the components can be stored separately in the cartridge, that the closure stopper is opened as required, and that a mixer is placed onto each of the outlet openings so that the two components cannot only be dispensed simultaneously, but are also mixed simultaneously.

The part chambers of the multicomponent cartridge can either be arranged next to one another or the first storage chamber can be arranged within the second storage chamber.

An expulsion element can be arranged in each of the storage chambers to dispense the filler material from the storage chamber. The expulsion element in the embodiment of the cartridge as a multicomponent cartridge for the simultaneous conveying of a plurality of flowable components includes a first piston and at least one second piston. The first piston is movably receivable in the first part chamber and the second piston is movably receivable in the second part chamber so that, on the movement of at least one of the first or second pistons, the first and second flowable components can be dispensed simultaneously.

The first and second pistons are movable by means of a plunger in accordance with a preferred embodiment. The plunger can be made in one piece with the first or second piston. The plunger can also be part of a dispensing device such as an expulsion gun, for example.

The first outlet passage and the second outlet passage can be arranged in the neck. The first outlet passage opens into a first outlet opening which is arranged in a first end of the neck. The second outlet passage opens into a second outlet opening which is arranged in a second end of the neck. The first end of the neck can extend within the second end of the neck so that the second end is arranged around the first end in ring form. The first end can in particular be arranged concentrically within the second end.

Alternatively to this, the second end can be arranged next to the first end. The first end and the second end are separated from one another by a partition wall.

In each of the cases, the second end is received in the neck such that the neck has a rotationally symmetrical outer side, that is in particular a cylindrical or conical outer side. This has the advantage that the neck can have a fastening means for the mixer at its outer side. The already described external thread can in particular be provided for this purpose.

In accordance with a particularly preferred embodiment, the first outlet opening is arranged coaxial to the second outlet opening and the first outlet passage is arranged within the second outlet passage, with the first outlet passage being separated from the second outlet passage by an intermediate wall. The intermediate wall is in this case arranged concentrically to the jacket of the neck. The first component thus flows in the interior of the intermediate wall which bounds the first outlet passage.

The second component flows outside the intermediate wall through the second outlet passage which is arranged around the first outlet passage in ring shape.

Alternatively to this, the first outlet passage can be arranged next to the second outlet passage. The first outlet opening is arranged next to the second outlet opening and the first outlet passage is arranged next to the second outlet passage, with the first outlet passage being separated from the second outlet passage by an intermediate wall.

In accordance with a variant, the first outlet passage can be received in a first neck and the second outlet passage can be received in a second neck. The respective neck of the cartridge can be made as a tubular stub which contains a respective outlet passage. The first outlet passage is connected to the first part chamber and the second outlet passage is connected to the second part chamber.

In this case, the mixer is placed onto the first and second necks to connect the outlet passages located in the respective neck so that the first and second components are only led together and mixed in the mixer.

In accordance with an alternative embodiment, the outlet passages extend in a single neck. The neck also contains a partition wall in this case; however, this partition wall divides the cross-sectional surface into two parts. Depending on the desired proportion of the components in the mixture, the parts can have equal cross-sectional areas or can also have cross-sectional areas differing from one another. A plurality of partition walls can naturally also be provided. The partition walls can divide the cross-section into individual segments or sectors so that the outlet passages are essentially arranged next to one another.

The storage chamber or the first and second part chambers can be at least partly transparent so that the filling level can be controlled. The housing is in particular made of a transparent material, for example of a transparent plastic, so that it is visually recognizable for the user on the filling of the cartridge how much filler material is already in the storage chamber. It is recognizable in the same way for each of the first or second part chambers how high the portion of the first or second flowable components is in the filling volume. A scale can be attached to the outer side of the housing in the region of the storage chamber or of the first or second part chambers which contains an indication for the user on which filling volume the already filled in filler matter contains.

It is accordingly also possible to fill the cartridge only in part if only a part of the filling volume is required. The dispensing of an adhesive or of a sealing material can be named as an example for such an application, for example. Depending on the size of the adhesion point or of the point to be sealed, the cartridge can be filled precisely with the quantity of filler material required for this purpose or precisely with the plurality of flowable components which are required at the adhesion point or at the point to be sealed.

The invention will be explained in the following with reference to the drawings. There are shown:

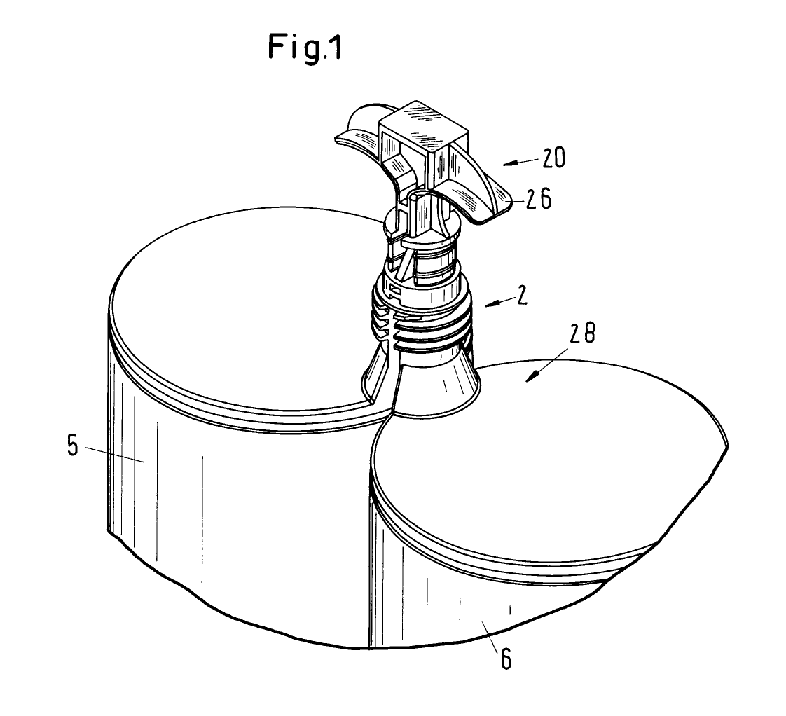

FIG. 1 a view of the cartridge and of the closure stopper in accordance with a first embodiment of the invention;

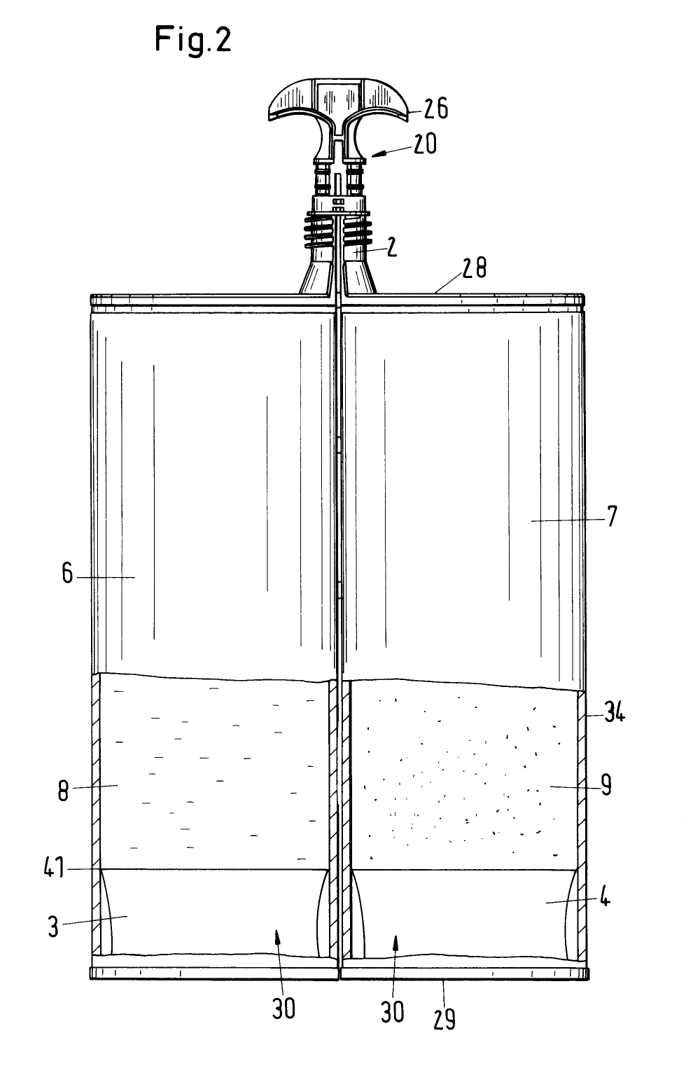

FIG. 2 a front view of the cartridge;

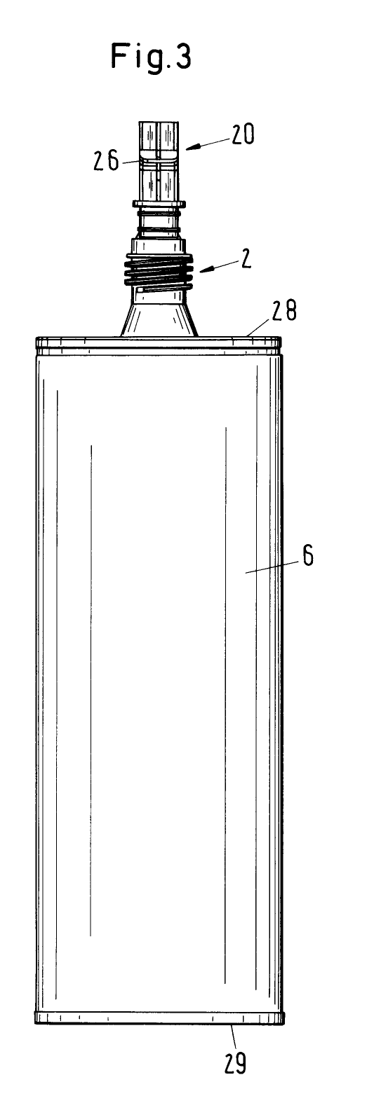

FIG. 3 a side view of the cartridge;

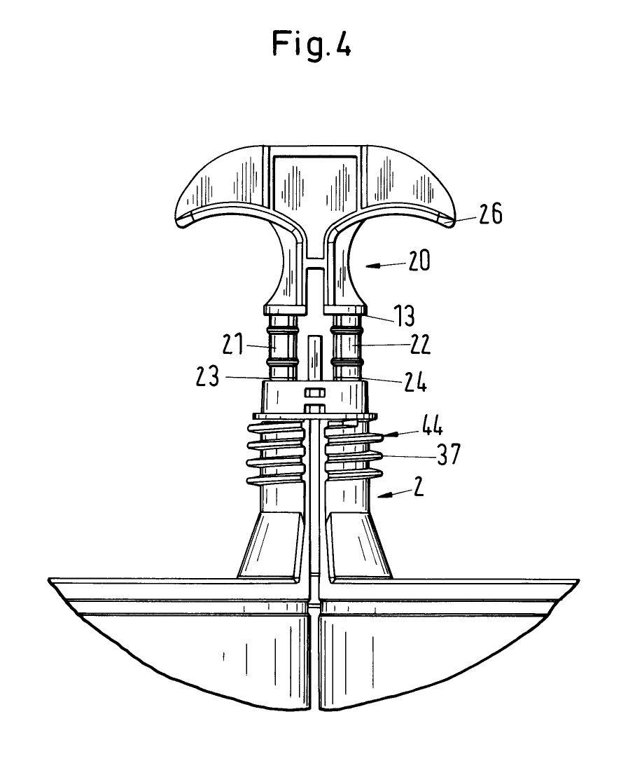

FIG. 4 a front view of the neck and of the closure stopper of the cartridge;

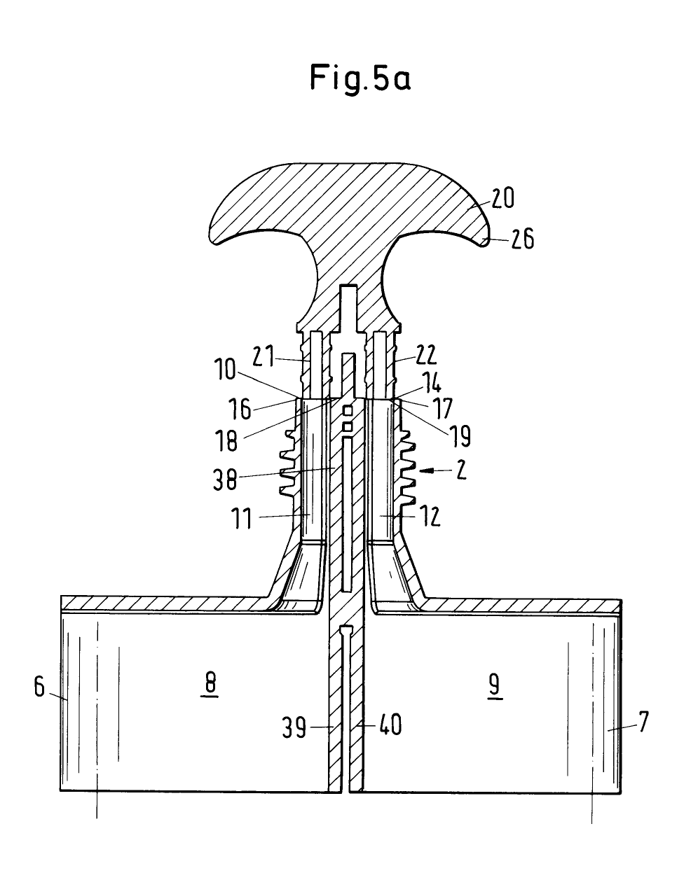

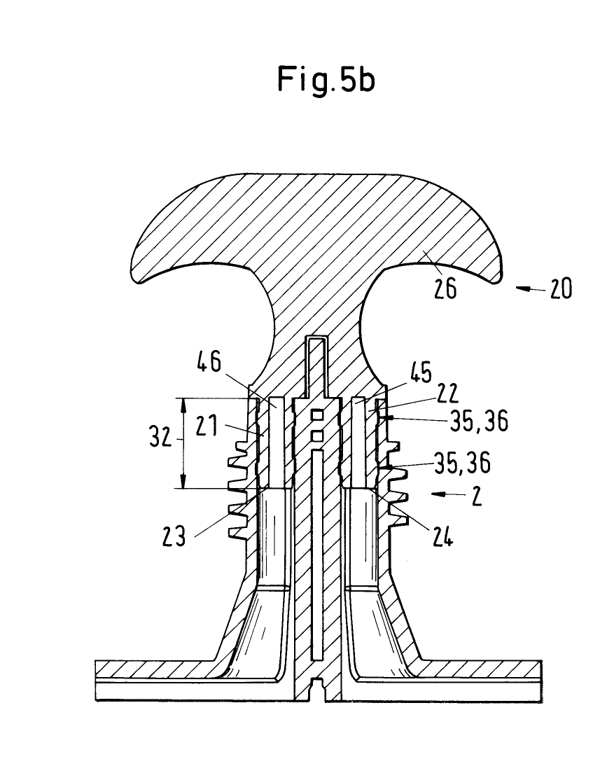

FIG. 5a a section through the neck and through the closure stopper of the cartridge in accordance with FIG. 4 before the first opening;

FIG. 5b a section through the neck and through the closure stopper of the cartridge in accordance with FIG. 4 after the reclosing;

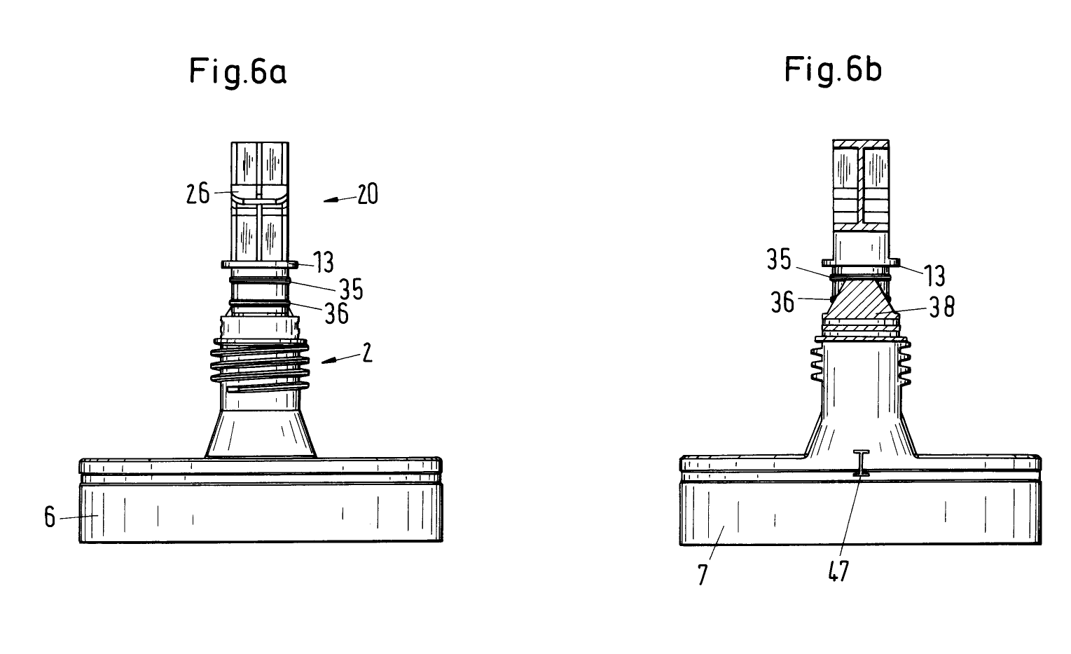

FIG. 6a a side view of the neck and of the closure stopper;

FIG. 6b a section through the neck and through the closure stopper of the cartridge in accordance with FIG. 6a

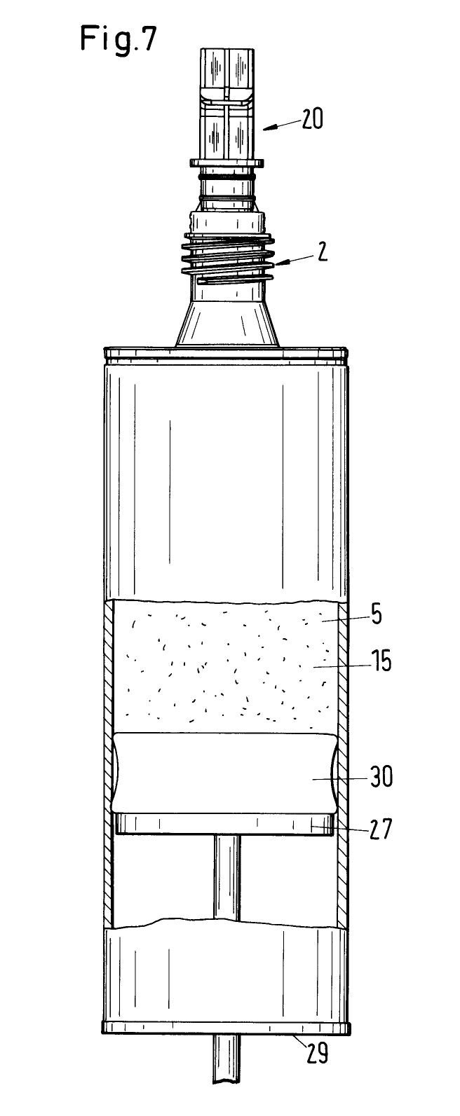

FIG. 7 a view, partly in section, of a cartridge for a filler material;

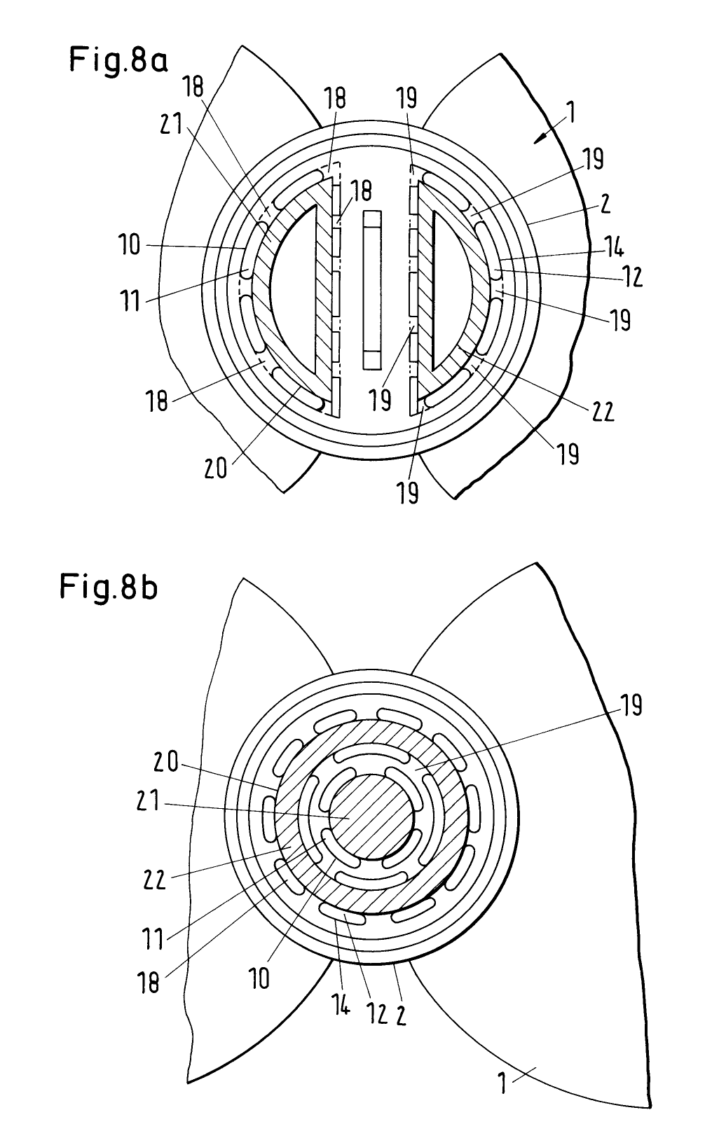

FIG. 8a a section through a closure stopper which is connected via bridge elements to a neck of a cartridge made of two outlet passages disposed next to one another; and

FIG. 8b a section through a closure stopper which is connected via bridge elements to a neck of a cartridge made of two outlet passages arranged coaxial to one another.

FIG. 1 shows a first embodiment of the cartridge 1 in accordance with the invention which serves for the metering of a filler material 15 made up a plurality of components 8, 9. The cartridge 1 contains two storage chambers which are made of a first part chamber 6 for the reception of a first component 8 and of a second part chamber 7 for the reception of a second component 9 of the filler material. The part chambers 6, 7 have an outlet end 28 to dispense the components 8, 9 and a conveying end 29 which is disposed opposite the outlet end 28 and which is visible in FIG. 2 or FIG. 3. The part chambers 6, 7 thus extend in accordance with FIG. 2 in the tubular section between the conveying end 29 and the outlet end 28.

Each of the part chambers 6, 7 is surrounded by a housing 34 so that the two components 8, 9 can be received in the corresponding first and second part chambers 6, 7. So that the components 8, 9 cannot be discharged from the corresponding part chambers 6, 7 in an uncontrolled manner, each of the first and second part chambers 6, 7 is adjoined by a respective outlet passage 11, 12 which is located in a neck 2. A first outlet passage 11 is shown in FIG. 5 which is located next to a second outlet passage 12. The first outlet passage 11 can be arranged substantially coaxial to the second outlet passage 12, which is not shown in the drawings. The first and second outlet passages 11, 12 in accordance with FIG. 5a or FIG. 5b open into a corresponding outlet opening 10, 14. This outlet opening 10, 14 is closable by a closure stopper 20.

FIG. 2 shows a front view of the cartridge, with the cartridge being shown partly sectioned. The parts of the cartridge already described in connection with FIG. 1 will not be looked at further at this point. It can be clearly recognized in the sectional representation that the first part chamber 6 is separated from the second part chamber 7 so that the two components 8, 9 do not come into contact with one another. Such components usually interact with one another as soon as they come into contact with one another, with chemical reactions being able to take place. The interaction of the components is usually the effect which is required in an application; however, this interaction is unwanted as long as the components are not used within the framework of the intended application for them.

The first part chamber 6 and the second part chamber 7 open into a respective outlet passage 11, 12 each which is arranged in the interior of the neck 2 of the cartridge, as shown in FIG. 5a or FIG. 5b.

As is shown in part in FIG. 2, an expulsion element 30 can be arranged in each of the part chambers 6, 7 to dispense the corresponding flowable component 8, 9 from the part chamber 6, 7. The cartridge 1 can be closed by the closure element on the conveying end 29. The closure element can be made as an expulsion element 30. In FIG. 2, the expulsion element 30 is made up of a first piston 3 and a second piston 4. The first piston 3 is movably receivable in the first part chamber 6 and the second piston 4 is movably receivable in the second part chamber 7 so that, on the movement of at least one of the first or second pistons, 3, 4 the first and second flowable components 8, 9 can be dispensed simultaneously. For this purpose, the first piston 3 and the second piston 4 and the plunger, not shown, are connected to one another via a coupling element such that they are movable simultaneously.

When the closure stopper 20 is closed and the closure element is located at the conveying end 29, each of the components 8, 9 is enclosed in the corresponding part chamber 6, 7 and is storage for at least a limited time period.

The first and the second pistons 3, 4 have at least one sealing element 41 which can in particular be made as a sealing lip. A leak of the components 8, 9 can hereby be avoided so that the components can be stored in the part chambers 6, 7.

FIG. 3 shows a side view of the cartridge 1 in accordance with FIG. 1 for a plurality of components. In FIG. 3, only the first part chamber 6 for a first component 8 is visible; the second part chamber is hidden. The part chambers can naturally also have different volumes if the mixing ratio differs from a mixing ratio of 1:1, that is one of the part chambers can have a correspondingly larger volume than the other part chamber.

FIG. 4 shows a view of the neck 2 and of the closure stopper 20 of a cartridge in accordance with one of the FIGS. 1 to 3. The closure stopper 20 contains a first arm 21 and a second arm 22. The two arms are used for the simultaneous dispensing of the first component 8 and of the second component 9. The first arm 21 has a first end 23 and the second arm 22 has a second end 24. Each of the first and second arms 21, 22 can be introduced into the corresponding outlet passage of the cartridge up to an abutment 13. The spacing between the abutment 13 and the end 23, 24 of the first or second arms 21, 22 is called the engagement length in the following.

An engagement element 44 which is in particular made as an external thread 37 is formed at the outer side of the neck 2. The engagement element 44 serves for the reception of a housing element, not shown. The housing element has a coupling element which engages into the engagement element. The housing element can, for example, be a mixer housing of a static mixer.

FIG. 5a shows a section through the neck 2 of the cartridge 1 in accordance with FIG. 4 before the first opening process. FIG. 5a shows a part of the first and second part chambers 6, 7 for the reception of the first and second components 8, 9 and a neck 2 which contains a respective outlet passage 11, 12 for the corresponding components 8, 9 so that the components 8, 9 can be dispensed from the associated part chamber 6, 7 through the outlet passage 11, 12. The components 8, 9 are discharged through an outlet opening 10, 14 arranged at the corresponding end 16, 17 of the outlet passage 11, 12 when the closure stopper 20 is remote from the outlet opening.

The closure stopper is formed in one piece with the neck 2, that is it is manufactured together with the neck 2. Since the neck 2 is also manufactured in one piece with the part chambers 6, 7, the cartridge is made up of the part chambers 6, 7, the neck 2 and the closure stopper 20. The cartridge is a single component which is preferably manufactured in an injection molding process.

The first end 23, 24 of the arm is connected to the neck 2 by a bridge element 18, 19, with a desired break point being formed by the bridge element 18, 19 and the closure stopper 20 being connected via the bridge element 18, 19 in one piece with the cartridge 1.

The closure stopper 20 has a second end 26, with the bridge elements 18, 19 being cut table once before the first use by manipulation of the second end 26 and with the corresponding arm 21, 22 subsequently being introductive by means of the handle 26 into the corresponding outlet opening 10, 14 to close the outlet opening 10, 14 again.

The closure stopper 20 advantageously projects beyond the neck 2 so that, on an impact, there is only contact with the closure stopper 20 made as an impact absorption element which can deform plastically, with the neck 2 located thereunder remaining intact, however.

The outlet passages can be arranged concentric to one another; in this connection, the term coaxial outlet is frequently used. In this case, the outlet passage 11 is located within the outlet passage 12. The outlet passage 12 thus surrounds the outlet passage 11 in the manner of a ring. This variant is not shown graphically.

FIG. 5b shows a section through the neck 2 and the closure stopper 20 of the cartridge in accordance with FIG. 4 or 5a after the reclosing. The arm 21, 22 has an abutment 13, with the arm 21, 22 being introductive into the outlet passage up to the abutment 13. An engagement length 32 is formed between the abutment 13 and the first end 23, 24 of the arm 21, 22. The arm 21, 22 is introduced into the outlet passage 11, 12 along the engagement length 32 when the closure stopper 20 is closed again.

A sealing element 35, 36 is advantageously provided to close the outlet opening 10, 14 in a fluid-tight manner again after cutting the bridge element 18, 19. The sealing element 35, 36 is a notch arranged, for example, at the outer side of the arm 21, 22; a plurality of notches can also be arranged after one another. The outer side of the arm 21, 22 can also be conical at least sectionally. The diameter of the cone advantageously increases as the engagement length 32 increases so that the arm 21, 22 is connected to the outlet passage 11, 12 in a fluid-tight manner by a compression force.

The arm 21, 22 advantageously has a cut-out 45, 46. The arm 21, 22 is elastic in the region of the engagement length 32 due to this cut-out 45, 46 so that the arm 21, 22 can deform elastically. The arm 21, 22 can hereby be introduced more simply into the corresponding outlet passage 11, 12. If the arm 21, 22 has a slight excess dimension with respect to the outlet passage 11, 12, an additional clamping connection can be provided on the reclosing of the outlet passage 11, 12. The cut-out 45, 46 is advantageously made as a bore which extends into the arm 21, 22 at least over the engagement length 32.

The first and second pistons 3, 4 are movable by means of a plunger 27 to dispense the two components 8, 9 simultaneously. The plunger 27 is in particular designed so that it lies on the first and second pistons 3, 4. Such a plunger 27 is shown in FIG. 7 for a single-component cartridge.

FIG. 6a shows a side view of the neck 2 and of the closure stopper 20. The second end 26 reaches up to the abutment 13. The sealing elements 35, 36 are furthermore visible. The view in accordance with FIG. 6a is the view of FIG. 5a from the left. This means that only the first part chamber 6 is visible.

The section through the neck 2 and the closure stopper 20 of the cartridge 1 in accordance with FIG. 6b is offset by 90° with respect to the section in accordance with FIG. 5a and contains the longitudinal axis of the neck 2. The section shows the intermediate wall 38 which separates the first outlet passage 11 from the second outlet passage 12. A portion of the intermediate wall 38 can be hollow for reasons of saving material. It is more advantageous from a technical injection molding aspect if the wall thicknesses of the neck 2, of the intermediate wall 38 and of the walls 39, 40 of the part chambers are of the same order of magnitude. Hollow spaces or cut-outs such as are visible in FIG. 5a are therefore provided in the intermediate wall 38 or in the walls 39, 40 between the two part chambers 6, 7.

Because the section of FIG. 6b extends exactly between the part chambers 6 and 7, only the part chamber 7 can be seen in FIG. 6b. A connection web 47 is shown which connects the part chamber 6 to the part chamber 7.

FIG. 7 shows a view, partly in section, of a cartridge 1 for a filler material 15 with a neck 2 and a closure stopper 20. A storage chamber 5 extends in the tubular section between the conveying end 29 and the outlet end 28. The storage chamber 5 is surrounded by a housing 34 so that the filler material 15 can be received in the storage chamber 5. So that the filler material 15 cannot be discharged from the storage chamber 5 in an uncontrolled manner, the storage chamber 5 contains a neck 2 in which an outlet passage 11 is located. The outlet passage 11 is, as is shown in the preceding embodiments, closable by a closure stopper 20 whose structure only differs from the preceding embodiments in that it only has a single arm 21.

The cartridge 1 can be closed by a closure element on the conveying end 29. The closure element can be made as an expulsion element, for example as a piston 3, which is displaceable in the storage chamber. When the closure stopper 20 is closed and the closure element is located at the conveying end 29, the filler material 15 is enclosed in the storage chamber 5 and is storage for at least a limited time period.

At least one of the storage chambers 5, 6, 7 can be at least partly transparent in accordance with each of the embodiments so that the filling level of the filler material 8, 9, 15 can be controlled in the corresponding storage chamber 5, 6, 7.

The provision of the cartridge 1 includes the steps of manufacturing the cartridge 1 and the filling of the cartridge 1 with a filler material 8, 9, 15. The operation of the cartridge includes the dispensing of the filler material 8, 9, 15 from the storage chambers 5, 6, 7 of the cartridge 1.

For the manufacture of the cartridge 1, in a first step, the storage chamber 5, 6, 7 for the reception of the filler material 8, 9, 15, a neck 2 which contains an outlet passage 11, 12 for the filler material 8, 9, 15, and a closure stopper 20 are manufactured in a single workstep in the injection molding process. The outlet passage 11, 12 has an end 16, 17, with an outlet opening 10, 14 being arranged at the end 16, 17 of the outlet passage 11, 12. The closure stopper 20 has an arm 21, 22, with the outlet opening 10, 14 being held closed by the arm 21, 22 of the closure stopper 20. The arm 21, 22 has a first end 23, 24, with the first end 23, 24 of the arm 21, 22 being connected to the neck 2 by a bridge element 18, 19. A desired break point is formed by the bridge element 18, 19 and the closure stopper 20 is connected to the cartridge 1 in one piece via the bridge element 18, 19. The closure stopper 20 has a second end 26 so that, in a second subsequent step, the bridge element 18, 19 is cut before the filling of the cartridge 1 with the filler material 8, 9, 15 by a manipulation of the second end 26 and, subsequently, the arm 21, 22 is introduced into the outlet opening 10, 14 to close the outlet opening 10, 14 again. The second end 26 can in particular be formed as a handle.

If the cartridge 1 in accordance with one of the preceding embodiments is filled, the filling includes the following steps:

docking the cartridge 1 to a reservoir for the filler material by connecting the storage chamber 5, 6, 7 to a conveying element arranged at the conveying end 29 of the cartridge 1;

introducing the filler material 8, 9, 15 into the storage chamber 5, 6, 7 by means of the conveying element;

and closing the filled supply chamber 5, 6, 7 by means of an expulsion element 3, 4, 30 at the conveying end 29.

During the filling of the cartridge with filler material 8, 9, 15, the arm 21, 22 can be removed so far from the outlet opening 10, 14 that air enclosed between the filler material 8, 9, 15 and the outlet opening 10, 14 can be discharged.

After the filling, the arm 21, 22 can be introduced into the outlet passage 11, 12 up to an abutment 13 so that an engagement length 32 is formed between the abutment 13 and the first end 23, 24 of the arm 21, 22 so that the arm 21, 22 is introduced into the outlet passage 11, 12 along the engagement length 32 so that the filler material 8, 9, 15 is enclosed in the cartridge 1.

The dispensing of the filler material 8, 9, 15 includes the following steps:

opening the closure stopper 20 by actuating the first end 26 and cutting the bridge element 18, 19;

dispensing the filler material 8, 9, 15 in that it is pressurized in the supply chamber 5, 6, 7, for which purpose the expulsion element 3, 4, 30 is displaced such that the filling volume in the supply chamber 5, 6, 7 reduces.

The dispensing of the filler material 8, 9, 15 can be interrupted at any time in that each of the arms 21, 22 of the closure stopper 20 is introduced through the associated outlet opening 10, 14 into the associated outlet passage 11, 12 and sealingly closes it.

FIG. 8 shows a section through the closure stopper 20 which represents an embodiment for the bridge elements for a neck 2 of a cartridge 1 made up of two outlet passages 11, 12 disposed next to one another. The section is placed in direct proximity to the outlet openings 10, 14. The two outlet openings 10, 14 are arranged next to one another and have approximately the shape of a sector of a circle. The first arm 21 and the second arm 22 of the closure stopper are connected to the walls of the corresponding outlet openings 10, 14 via the bridge elements 18, 19. The bridge elements 18, 19 are formed as webs, that is at least one respective opening is located between the bridge elements. This opening serves for the increase of the notch effect so that a cutting of the bridge elements 18, 19 requires the exertion of a small force before the first use of the cartridge. It must be noted that the bridge elements have the object during the manufacturing process of conducting polymer melt into the cavity for the closure stopper. This means that the wall thickness of the bridge elements has to be so large that the flow of the polymer melt is not unnecessarily braked by this restriction. The injection pressure of the polymer melt into the cavity should be kept as small as possible so that there are no delays on the filling of the cavity for the closure stopper. Such a delay would extend the throughput time of the manufacture of the cartridge, which would increase the costs for the manufacture of the cartridge.

FIG. 8b shows a section through a closure stopper 20 which is connected via bridge elements 18, 19 to a neck 2 of a cartridge 1 made up of two outlet passages 11, 12 arranged coaxial to one another. The first arm 21 of the closure stopper 20 is arranged within the ring-shaped second arm 22. The designation of the bridge elements 18, 19 with reference numerals takes place only by way of example as with FIG. 8. The number and arrangement of the bridge elements can differ from the variants shown.

1. A method for the manufacture of a cartridge, wherein, in a first step, a storage chamber for the reception of a filler material, a neck which contains an outlet passage for the filler material, and a closure stopper are manufactured in a single workstep in an injection molding process; wherein the outlet passage has an end; wherein an outlet opening is arranged at the end of the outlet passage; wherein the closure stopper has an arm; wherein the outlet opening is held at least partly closed by the arm of the closure stopper; wherein the arm has a first end; wherein the first end of the arm is connected to the neck by a bridge element; wherein a desired break point is formed by the bridge element and the closure stopper is connected to the cartridge in one piece via the bridge element; wherein the closure stopper has a second end; wherein, in a second subsequent step, the bridge element is cut by manipulation of the second end before the filling of the cartridge with the filler material and subsequently the arm is introduced into the outlet opening to close the outlet opening.

2. A cartridge including a storage chamber for the reception of a filler material, a neck which contains an outlet passage for the filler material, and a closure stopper; wherein the storage chamber, the neck and the closure stopper are manufactured in a single workstep in an injection molding process; wherein the outlet passage has an end; wherein an outlet opening is arranged at the end of the outlet passage; wherein the closure stopper has an arm; wherein the outlet opening is held at least partly closed by the arm of the closure stopper; wherein the arm has a first end; wherein the first end of the arm is connected to the neck by a bridge element; wherein a desired break point is formed by the bridge element and the closure stopper is connected to the cartridge in one piece via the bridge element; wherein the arm has a second end, which is arranged oppositely to the first end, characterized in that the bridge element can be cut by manipulation of the second end before the filling of the cartridge with the filler material and subsequently after the cutting of the bridge element the arm can introduced into the outlet opening to close the outlet opening, whereby the bridge element contains at least one opening.

3. A cartridge in accordance with claim 2, wherein the bridge element is made as a web.

4. A cartridge in accordance with claim 2, wherein the arm has an abutment; wherein an engagement length is formed between the abutment and the end of the arm so that the arm is introduced into the outlet passage along the engagement length when the closure stopper is closed; and wherein the position of the arm in the outlet passage is changeable by means of the second end.

5. A cartridge in accordance with claim 4, wherein a sealing element is provided to close the outlet opening in a fluid-tight manner.

6. A cartridge in accordance with claim 5, wherein the sealing element is a bead arranged on the outside of the arm.

7. A cartridge in accordance with claim 5, wherein the sealing element is a bead arranged on the inner side of the outlet passage.

8. A cartridge in accordance with claim 6, wherein a plurality of beads are arranged behind one another.

9. A cartridge in accordance with claim 4 wherein the outer side of the arm is conical at least sectionally.

10. A cartridge in accordance with claim 4, wherein the outlet passage is conical at least sectionally.

11. A cartridge in accordance with claim 4, wherein the arm has a cut-out.

12. A cartridge in accordance with claim 11, wherein the cut-out is made as a bore which extends at least over a portion of the engagement length in the aim.

13. A cartridge in accordance with claim 4, wherein a first outlet passage and a second outlet passage are arranged in the neck.

14. A cartridge in accordance with claim 13, wherein the first outlet passage has a first outlet opening and the second outlet passage has a second outlet opening; wherein the first outlet opening is arranged coaxial to the second outlet opening and the first outlet passage is arranged within the second outlet passage; and wherein the first outlet passage is separated from the second outlet passage by an intermediate wall.

15. A cartridge in accordance with claim 13, wherein the first outlet passage has a first outlet opening and the second outlet passage has a second outlet opening; wherein the first outlet opening is arranged beside second outlet opening and the first outlet passage is arranged beside the second outlet passage; and wherein the first outlet passage is separated from the second outlet passage by an intermediate wall.

16. A cartridge in accordance with claim 2, wherein the second end is formed as a handle.
